(19) United States
(12) Patent Application Publication
(10) Pub. No.: US 2008/0284307 A1
(43) Pub. Date: Nov. 20, 2008

(54) METHOD FOR DRIVING CATHADE OF FIELD EMISSION DISPLAY AND STRUCTURE OF THE SAME

(76) Inventor: Chih-Che Kuo, Taipei City (TW)

Correspondence Address: HDSL, 4331 STEVENS BATTLE LANE, FAIRFAX, VA, 22033, US

(21) Appl. No.: 11/748,782

(22) Filed: May 15, 2007

(51) Int. Cl. H01J 63/04

(52) U.S. Cl. 313/495

(57) ABSTRACT

A field emission display includes a cathode plate and an anode plate. The anode plate is provided with an anode unit thereon. The cathode plate is provided on a cathode substrate with two electrodes that are located in a common plane and separated from each other to correspond to a common anode unit. Cathode electron-emitters are provided on the two electrodes respectively. A reverse voltage is applied to the two electrodes alternately, causing the alternation of the positive and negative voltages between the two electrodes. As a result, the two electrodes form a gate and an emitter alternately based on the applied positive or negative voltage. Therefore, the cathode electron-emitter provided on the coplanar electrodes will generate electron beams alternately.

### BACKGROUND OF THE INVENTION

1. Field of the Invention

The present invention relates to a field emission flat panel display, and in particular to a method for driving a cathode plate having a coplanar structure and the structure of the same.

2. Description of Prior Art

In recent years, since the flat panel display is light and thin, and the definition and the brightness thereof are superior to those of a conventional television, the flat panel display can be widely used in various displays having different dimensions in a range from a small mobile screen to a outdoor advertisement board. Therefore, the flat panel display becomes more and more popular.

Various kinds of flat panel displays are continuously proposed in the market, such as liquid crystal display (LCD), plasma display panel (PDP), organic light-emitting diode (OLED), field emission display (FED) or the like. Especially, the field emission display (FED) is one of the newly developed flat panel displays. The principle thereof lies tin that a cathode electron-emitter provided within the internal structure is used to generate electron beams so as to collide with a corresponding fluorescent layer to generate light, thereby providing a sufficient brightness to act as a light-emitting source for the flat panel display.

As far as prior art is concern, the field emission display uses a tri-pole structure including an anode plate and a cathode plate. A supporter is provided between the anode plate and the cathode plate, which not only acts as a supporting means, but also acts as a vacuum area partition between the anode plate and the cathode plate for an electron-moving space. The anode plate further comprises an anode substrate. The substrate is provided with a conductive layer thereon. Finally, the conductive layer is provided with a fluorescent layer thereon. Further, the cathode plate includes a cathode substrate. The cathode substrate is provided with a conductive layer. The conductive layer is provided with a cathode electron-emitter and a gate layer. The gate layer provides a potential difference so that the cathode electron-emitter can generate electrons. Finally, the anode conductive layer provides a high voltage to supply kinetic energy for accelerating the electrons, thereby colliding with the fluorescent layer of the anode substrate to generate light.

Although the aforementioned conventional structure can provide a light-emitting effect for the field emission display, the gate layer is designed to be provided between the cathode electron-emitter and the anode directly and is temporarily connected on the cathode electron-emitter, which causes the production of the cathode plate to be more complicated and results in a high cost. Therefore, in order to reduce the cost and overcome the drawbacks of the aforementioned structure, the later-developed prior art proposes a cathode structure in which the cathode electron-emitter and the gate are provided in a common plane, such as that disclosed in US Patent Publication No. 2006/0175954 Via this structure, not only the production procedure is simpler, but also the production cost is substantially reduced.

Although the aforementioned coplanar structure in which the cathode electron-emitter and the gate are formed on the cathode substrate indeed reduces the complexity of the production procedure, the coplanar arrangement has to occupy a larger planar space. As a result, it cannot conform to the requirement for a compact dimension and cannot provide a high level of definition. Further, the uniformity of the light-emitting area is restricted, and thus it is necessary to provide with a reflective layer or a diffusion plat additionally. Therefore, the aforementioned coplanar structure still has some drawbacks.

### SUMMARY OF THE INVENTION

In view of the above drawbacks, the present invention is to provide a method for driving a cathode of a field emission display and the structure of the same whereby a reverse voltage can be used to generate electron beams. According to the present invention, the improvement over the coplanar structure of the conventional cathode plate lies in that the cathode plate is provided with a plurality of coplanar and separate electrodes. Further, an alternating variable voltage is applied to the plurality of mutually corresponding electrodes, so that the corresponding electrodes act as a gate and an emitter respectively based on the positive or negative voltage thereof. In this way, electrons can be generated to collide with the corresponding anode plate.

In order to achieve the above objects, the present invention provides a method for driving a cathode of a field emission display and the structure of the same. The display includes a cathode plate and an anode plate. The anode plate is provided with an anode unit thereon. The cathode plate is provided on a cathode substrate with two electrodes that are located in a common plane and separated from each other to correspond to a common anode unit. Cathode electron-emitters are provided on the two electrodes respectively. A reverse voltage is applied to the two electrodes alternately, causing the alternation of the positive and negative voltages between the two electrodes. As a result, the two electrodes form a gate and an emitter alternately based on the applied positive or negative voltage. Therefore, the cathode electron-emitters provided on the coplanar electrodes will generate electron beams alternately to collide with the corresponding anode plate so as to generate light.

### BRIEF DESCRIPTION OF THE DRAWINGS

FIG. 1 is a cross-sectional view showing the structure of the present invention;

FIG. 2 is a schematic view showing the operation of the present invention;

FIG. 3 is an oscillogram showing the voltage period of the present invention; and

FIG. 4 is another oscillogram showing the voltage period of the present invention.

### DETAILED DESCRIPTION OF THE INVENTION

The technical contents of the present invention will be explained with reference to the accompanying drawings.

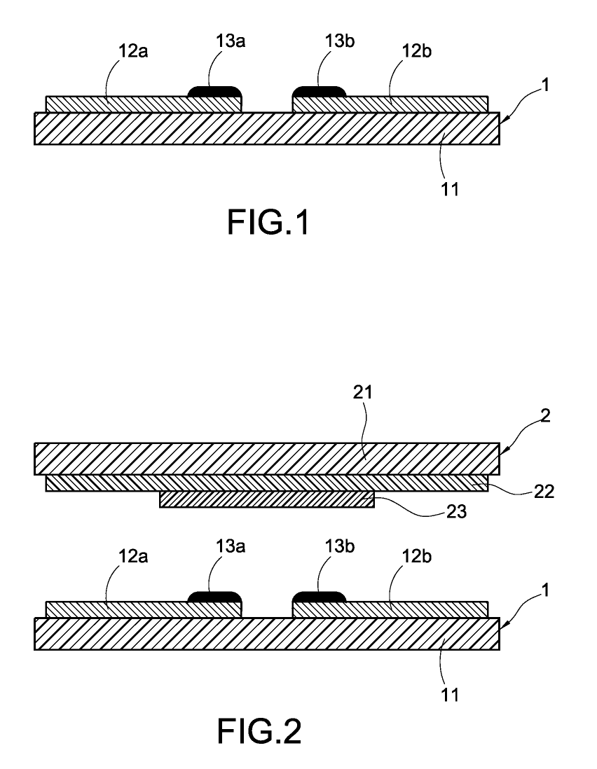

With reference to FIG. 1, it is a cross-sectional view showing the structure of the present invention. As shown in this figure, the cathode structure of the displaying element includes a cathode plate 1. The cathode plate 1 includes a cathode substrate 11. The cathode substrate 11 is provided with a plurality of electrodes 12a, 12b that are located in a common plane to correspond to each other. The electrodes 12a and 12b are provided with cathode electron-emitters 13a and 13b thereon, respectively. The cathode electron-emitters 13a and 13b correspond to a fluorescent layer 23 (FIG. 2) of an anode plate 2 collectively. The cathode electron-emitters 13a and 13b are electrically connected with the electrodes 12a and 12b. Via the difference between the voltages provided by the electrodes 12a and 12b, the cathode electron-emitters 13a and 13b are drawn to generate electrons so as to collide with the corresponding anode plate 2 (FIG. 2).

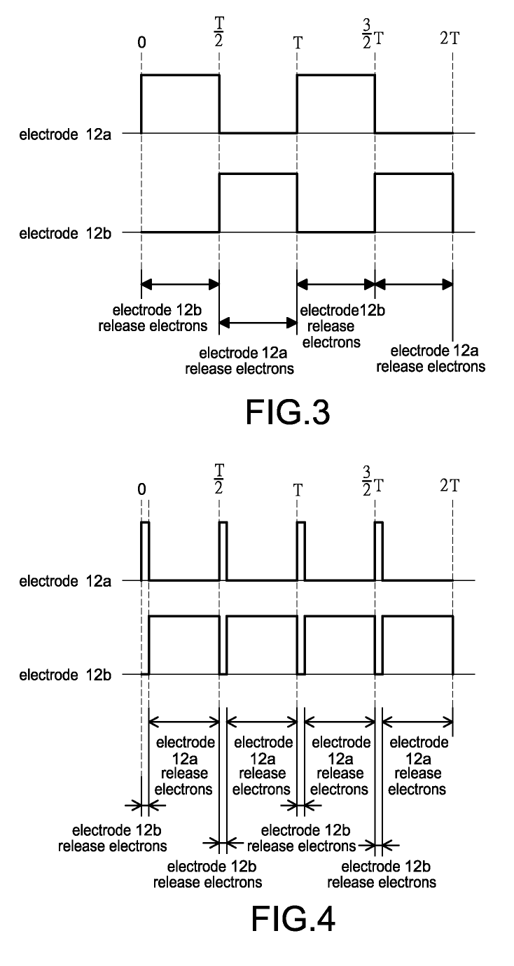

With reference to FIG. 2, it is a schematic view showing the operation of the present invention. As shown in this figure, the cathode plate 1 corresponds to an anode plate 2. The anode plate 2 has an anode substrate 21. The anode substrate 21 is provided with an anode conductive layer 22 thereon. The conductive layer 22 is provided with a fluorescent layer 23 thereon. Further, a way of driving and controlling the electrodes 12a and 12b that are located in a common plane and correspond to each other is provided. Via a periodic reverse voltage, the corresponding electrodes 12a and 12b can generate a voltage difference, and thus act as a gate and an emitter respectively based on the generated positive or negative voltage. In this way, under various voltage differences, the cathode electron-emitters 13a and 13b provided respectively on the electrodes 12a and 12b will generate an electron beam to collide with the fluorescent layer 23 of the corresponding anode plate 2. For example, with reference to FIG. 3, a reverse voltage of an oscillation signal with a phase contrast of π is applied to the electrodes 12a and 12b, that is, the period is 50%. As a result, the electrode 12a has a higher voltage while the electrode 12b has a lower voltage. At this time, the electrode 12a having a higher voltage acts as a gate, whereas the electrode 12b having a lower voltage acts as an emitter. Therefore, the voltage difference generated between the electrodes 12a and 12b draws the cathode electron-emitter 13b on the electrode 12b to release electrons to form electron beams, thereby colliding with the corresponding fluorescent layer 23 to generate light. When the applied voltage is reversed, the electrode 12a has a lower voltage while the electrode 12b has a higher voltage. At this time, the electrode 12b acts as a gate whereas the electrode 12a acts as an emitter, so that the cathode electron-emitter 13a on the electrode 12a can release electrons.

With reference to FIG. 4, it is an oscillogram of another voltage period of the present invention. As shown in this figure, a reverse voltage of an oscillation signal with a phase contrast of (¼)π is applied to the electrodes 12a and 12b, that is, the period is 25%. As a result, the electrode 12a has a higher voltage while the electrode 12b has a lower voltage. At this time, the electrode 12a having a higher voltage acts as a gate, whereas the electrode 12b having a lower voltage acts as an emitter. Therefore, the cathode electron-emitter 13b can generate electron beams. On the contrary, when the electrode 12b has a higher voltage and the electrode 12a has a lower voltage, the electrode 12b acts as a gate whereas the electrode 12a acts as an emitter, so that the cathode electron-emitter 13a generates electrons to collide with the corresponding anode plate 2

Furthermore, the electrons generated by the aforementioned way can be also used to control the amount of electrons generated by the cathode electron-emitter 13 via a pulse width modulation (PWM), thereby keeping an intermittent driving between the corresponding electrodes and improving the life and efficiency of the cathode plate 1.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A method for driving a cathode of a field emission display, comprising the steps of:
a) providing two separate and symmetrical electrodes on a cathode plate in a coplanar manner; and
b) applying a reverse voltage on the two electrodes alternately.

2. The method according to claim 1, wherein the reverse voltage applied in the step b) is a periodic reverse voltage.

3. A structure for driving a cathode of a field emission display, adapted to correspond an anode plate, the driving structure comprising a cathode plate, the cathode plate having a cathode substrate, the cathode substrate being provided thereon with a plurality of coplanar and separate electrodes that correspond to the anode plate collectively, wherein a reverse voltage is supplied to the plurality of corresponding electrodes, so that the plurality of electrodes act as a gate and an emitter based on the positive or negative voltage thereof.
